(19) United States
(12) Patent Application Publication
(10) Pub. No.: US 2002/0060828 A1
(43) Pub. Date: May 23, 2002

(54) Air dynamic pressure bearing and optical deflector

(76) Inventors: Yutaka Ishizuka, Nagano (JP); Hisaya Nakagawa, Nagano (JP); Michiaki Takizawa, Nagano (JP); Takafumi Kuwazawa, Nagano (JP); Toshimasa Kobayashi, Nagano (JP); Akitoshi Iizawa, Nagano (JP); Masao Takemura, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 09/971,370

(22) Filed: Oct. 3, 2001

(30) Foreign Application Priority Data
Oct. 24, 2000 (JP) 2000-323420

(51) Int. Cl. G02B 26/08

(52) U.S. Cl. 359/200

(57) ABSTRACT

An air dynamic pressure bearing includes a shaft element, a bearing element relatively rotatably supporting the shaft element, and dynamic pressure generation grooves for generating a dynamic pressure by air formed between opposing surfaces of the shaft element and the bearing element. The bearing element is formed from a sintered alloy, and a solid lubricant material is disposed on the opposing surface of at least one of the shaft element and the bearing element.

### BACKGROUND OF THE INVENTION

1. Field of the Invention

The present invention relates to an air dynamic pressure bearing with excellent durability, and an optical deflector in which the air dynamic pressure bearing is incorporated as its bearing.

2. Description of Related Art

In a rotation polygon mirror type optical deflector, a dynamic pressure bearing may be used as a bearing of the rotation polygon mirror. A liquid dynamic pressure bearing, which uses dynamic pressure of liquid lubricant such as oil, is generally used as the dynamic pressure bearing of the rotation polygon mirror type optical deflector.

The oil dynamic pressure bearing is typically equipped with a cylindrical bearing main body, and a rotor shaft rotatably supported within the bearing main body. The bearing main body is formed from a sintered metal, and the herringbone shape dynamic pressure generation grooves are formed on an internal peripheral surface of the bearing main body in a bearing axial direction.

However, in this type of liquid dynamic pressure bearing, the liquid lubricant filled in the bearing has a substantially high density compared to air used in the air dynamic pressure bearing, and its rotation resistance becomes large particularly at the time of high-speed rotation. As a result, problems such as increased power consumption of the motor that is a rotation driving power source occur. Also, the lubrication oil deteriorates with the use thereof, and the service life of the bearing can be generally guaranteed for only about 3,000 hours in a continuous operation at about 30,000 rmp.

In view of the above, air may be used instead of a liquid lubricant as a lubricant to provide an air dynamic pressure bearing. However, when air is used instead of a liquid lubricant with a liquid dynamic pressure bearing having the conventional structure, the following problems occur.

In a dynamic pressure bearing, a floating rotation state (non-contact rotation state) is formed by dynamic pressure that is generated by the lubricant when the rotation of the rotary shaft exceeds over a predetermined rotational speed. However, until such a state is established, the rotary shaft rotates in a state in which the rotary shaft is in contact with the bearing main body. Therefore, an air dynamic pressure bearing that is not filled with a liquid lubricant such as oil suffers a large amount of abrasion due to the contact rotation such that its service life becomes extremely short.

In order to reduce the harmful influence, it is important that the dynamic pressure generation groove of the air dynamic pressure bearing be formed with a high level of precision such that a target dynamic pressure is generated in a relatively low-speed rotation state to shorten the time period of the contact rotation state. However, the conventional dynamic pressure generation grooves are generally provided in a herringbone shape on an internal peripheral surface of the bearing main body along the bearing axial direction. As a result, when the grooves are formed by a metal mold, the metal mold cannot be separated from the grooves due to undercuts. Accordingly, the mold needs to be removed by using the differences in the thermal expansion coefficients of the materials or the spring back effect. However, this method involves complex steps and therefore is a cause behind low productivity and higher cost.

Furthermore, in removing a mold by using the differences in the thermal expansion coefficients by heating or cooling, or in removing a mold by using the spring back effect, these effects may not be provided sufficiently and the mold may not be removed when the diameter of the bearing is small. Therefore, the method described above is not suitable for manufacturing air dynamic pressure bearings of small size and small diameter.

### SUMMARY OF THE INVENTION

In view of the above, it is an object of the present invention to provide an air dynamic pressure bearing that can achieve a long service life.

Also, in addition to the above, it is another object of the present invention to provide an air dynamic pressure bearing in which its dynamic pressure generation grooves can be readily and accurately formed.

It is a further object of the present invention to provide an optical deflector of a rotation polygon mirror type that is equipped with a novel air dynamic pressure bearing.

In accordance with an embodiment of the present invention, an air dynamic pressure bearing may include a shaft element, a bearing element relatively rotatably supporting the shaft element, and a dynamic pressure generation groove for generating a dynamic pressure by air formed between opposing surfaces of the shaft element and the bearing element, wherein the bearing element may be formed from a sintered alloy, and solid lubricant is disposed on at least one of the opposing surfaces of the shaft element and the bearing element. As a result, the amount of abrasion of the bearing, which occurs in a contact rotation state that takes place when starting or stopping the shaft element, can be reduced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows a cross section of a half section of a rotation polygon mirror type optical deflector in accordance with an embodiment of the present invention.

FIG. 2 shows a graph showing relations between film thickness of electrodeposition coating films and the number of rotations until burning occurs.

FIG. 3(a) shows an end side view of a bearing member having dynamic pressure generation grooves provided in an air dynamic pressure bearing section of the optical deflector shown in FIG. 1, and FIG. 3(a) shows a perspective view of the same.

FIG. 4(a) shows an end side view of a bearing member having dynamic pressure generation grooves provided in an air dynamic pressure bearing section in accordance with another embodiment, and FIG. 4(a) shows a perspective view of the same.

FIG. 5 shows a cross section of another example of the optical deflector shown in FIG. 1.

### EMBODIMENTS OF THE PRESENT INVENTION

A rotation polygon mirror type optical deflector equipped with an air dynamic pressure bearing in accordance with an example of the present invention is described below with reference to the accompanying drawings.

(Overall Structure)

An optical deflector 1 of the present embodiment is equipped with a mounting frame 2. The frame 2 is mounted to, for example, a main chassis of a laser beam printer (not shown). A cylindrical bearing holder 3 that vertically extends (in the figure) along an axial direction is affixed to the frame 2. A cylindrical bearing member (bearing element) 4 is supported concentrically within the bearing holder 3. A rotor shaft (shaft element) 5 is rotatably supported within the bearing member 4, and a lower end surface of the rotor shaft 5 is rotatably supported by a thrust bearing plate 6. In the present embodiment, an air dynamic pressure bearing 1A is formed between the bearing member 4 and the rotor shaft 5. Also, an air dynamic pressure thrust bearing 1B is formed between the thrust bearing plate 6 and a lower end surface of the rotor shaft 5. For these bearings, dynamic pressure generation grooves 4b are formed in an internal peripheral surface of the bearing member 4 and dynamic pressure generation grooves 6a are formed in a surface of the thrust bearing plate 6.

An upper end section of the rotor shaft 5 upwardly protrudes from the upper end of the bearing member 4, and a disc shape hub 7 is concentrically affixed to the protruded end section of the rotor shaft 5. A circular stepped surface is formed in an external peripheral surface of the hub 7, and a regular hexagonal rotation polygon mirror 8 is concentrically mounted on the circular stepped surface of the hub 7. The rotation polygon mirror 8 is affixed to the hub 7 by a clamp 9 that is affixed to the upper end of the rotor shaft 5.

A stator core 11 equipped with a plurality of radially extending salient poles is affixed to the external periphery of the bearing holder 3, and a stator coil 12 is wound on each of the salient poles. A circular yolk 13 is affixed to a lower end surface of the hub 7 opposite to the salient poles. A drive magnet 14 in a ring shape is mounted on an internal peripheral surface of the yolk 13 in a manner to surround the stator core 11.

When current is applied to the stator coils 12 that are wound on the stator core 11, electromagnetic effect is generated by the drive magnet 14 and the stator core 11, and the rotor shaft 5 that is a member on the rotation side, and the rotation polygon mirror 8 mounted on the rotor shaft 5 through the hub 7 are rotated by the electromagnetic effect.

In the present embodiment, the bearing member 4 that forms the air dynamic pressure bearing 1A is a sintered bearing, which is formed from a sintered alloy of metal powder containing copper or iron as a main component. Also, a solid lubricant member is formed and disposed on a surface of the bearing member 4 opposing to the rotor shaft 5, in other words, on the internal peripheral surface 4a in which the dynamic pressure generation grooves 4b are formed.

(Solid Lubricant Material)

The solid lubricant material in accordance with the present embodiment may be formed and disposed as follows. At least one solid lubricant powder selected from the group consisting of fluorine, carbon and molybdenum disulfide is mixed with resin such as epoxy region or polyamide to form a mixed solution, and the mixed solution is coated to a specified thickness on the internal peripheral surface 4a of the bearing member to form a lubrication film thereon. Instead of coating, the bearing member 4 may be dipped in the mixed solution to adhere a lubricant film on the internal peripheral surface 4a of the bearing member.

Alternatively, in accordance with another embodiment, the solid lubricant may be provided as an electrodeposition coating film formed on the internal peripheral surface 4a of the bearing member, using an electrodeposition paint containing fluorine resin in which bismaleimide resin is mixed with a copolymer including one of (a) through (d) listed below,

(a) alkylester fluoride of acrylic acid or methacrylate acid,

(b) amino derivative of acrylic acid or methacrylate acid,

(c) hydroxy derivative of acrylic acid or methacrylate acid, and

(d) ester of styrene, acrylic acid or methacrylate acid.

In this case, the electrodeposition paint containing fluorine resin may preferably include PTFE and/or molybdenum disulfide. For example, 15% to 20% of PTFE may be included in the paint.

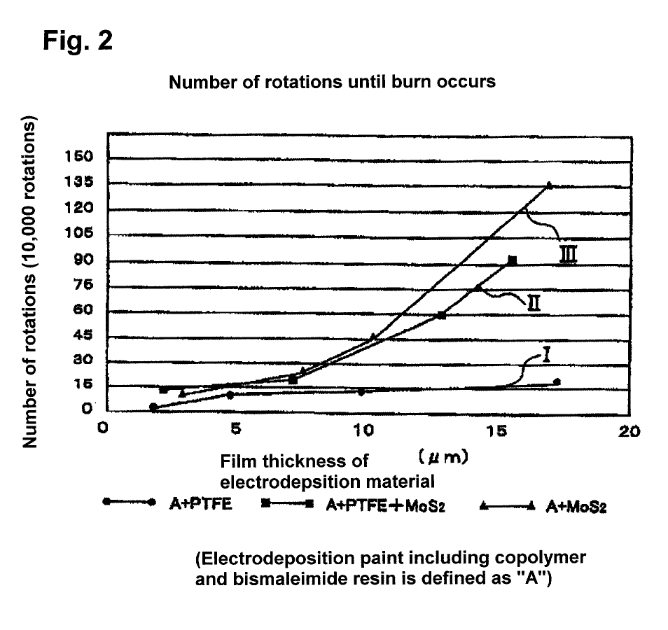

The inventors of the present invention measured relations between the film thickness and the number of rotations until burning takes place when an electrodeposition coating film that is composed of electrodeposition paint containing fluorine resin is formed on the internal peripheral surface 4a of the bearing member. The results are shown in a graph in FIG. 2. In the graph, a line I indicates the case when electrodeposition paint containing fluorine resin including PTFE is used as the electrodeposition paint. A line II indicates the case when electrodeposition paint containing fluorine resin including PTFE and molybdenum disulfide is used as the electrodeposition paint. A line III indicates the case when electrodeposition paint containing fluorine resin including molybdenum disulfide is used as the electrodeposition paint. In all of the cases, it is confirmed that the required bearing service life is obtained when the film thickness of the electrodeposition paint coat is 5 μm or greater. In particular, in the case indicated by the line II (when electrodeposition paint containing fluorine resin including PTFE and molybdenum disulfide is used as the electrodeposition paint), and in the case indicated by the line III (when electrodeposition paint containing fluorine resin including molybdenum disulfide is used as the electrodeposition paint), the service life is substantially extended when the film thickness is 8 μm or greater.

In the embodiment described above, the lubricant film is formed on the internal peripheral surface 4a of the bearing member 4. However, in another embodiment, the lubricant film may be formed on the external peripheral surface 5a of the rotor shaft 5.

Further, the solid lubricant material may be disposed on the side of the bearing member 4 that is formed from a sintered body by a different method, instead of forming a lubricant film. For example, solid lubricant material may be mixed with metal powder for the sintered alloy, and then the metal powder mixed with the solid lubricant material mixed therein may be sintered to mix the solid lubricant powder inside the bearing member 4.

In this case, at least one material selected from carbon graphite, molybdenum disulfide and boron nitride may be used as the solid lubricant powder.

Also, instead of directly mixing the solid lubricant powder with metal powder, resin that is mixed with the solid lubricant power may be mixed with metal powder and sintered.

(Dynamic Pressure Generation Grooves)

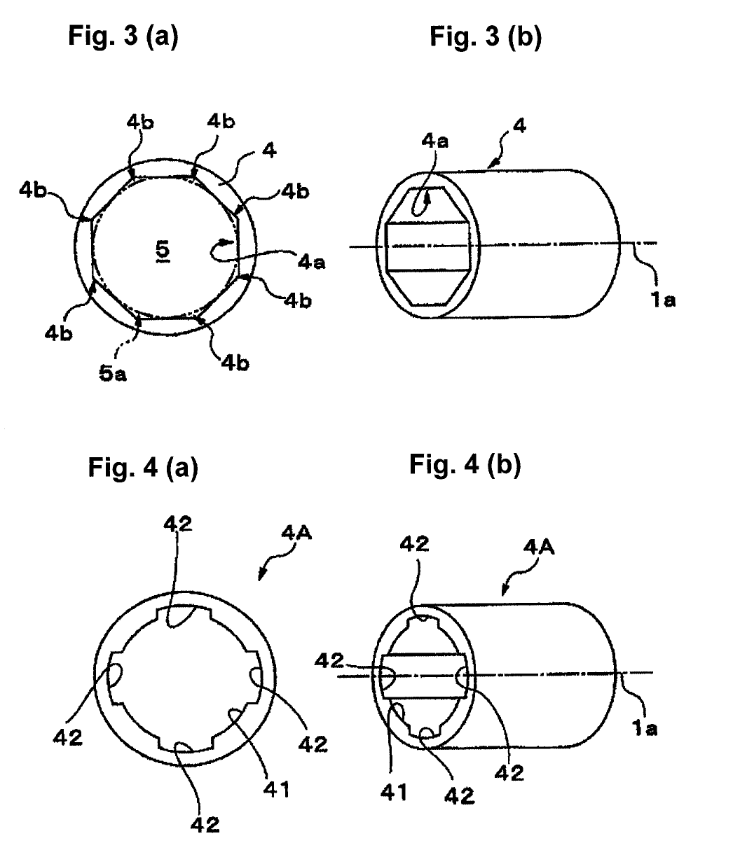

In the air dynamic pressure bearing 1A of the present embodiment, the dynamic pressure generation grooves 4b formed in the internal peripheral surface 4a of the bearing member 4 generally linearly extend along the bearing axial direction. FIGS. 3(a) and (b) respectively show a side end view and a perspective view of the bearing member 4. As shown in the figures, the dynamic pressure generation grooves 4b are defined by the external peripheral surface 5a of the rotor shaft 5 and the internal peripheral surface 4a of the bearing member 4 that is formed in a regular octagon that is slightly larger than a regular octagon that circumscribes the rotor shaft 5.

In this case, the dynamic pressure generation grooves 4b linearly extends in a direction in which a metal mold that is used to form the bearing member 4 is removed, in other words, in a direction of the bearing axis la. As a result, the bearing member 4 having highly precisely formed dynamic pressure generation grooves 4 can be readily manufactured at low cost.

FIGS. 4(a) and (b) respectively show a side end view and a perspective view of a bearing member 4A equipped with dynamic pressure generation grooves in a different shape. The bearing member 4A is provided with four dynamic pressure generation grooves 42 formed at angular intervals of 90 degree in a circular internal peripheral surface 41, and each of the dynamic pressure generation grooves 42 linearly extend in the bearing axial direction. The bearing member 4A equipped with the dynamic pressure generation grooves 42 can be readily and accurately manufactured.

(Modified Embodiments of Rotor Shaft)

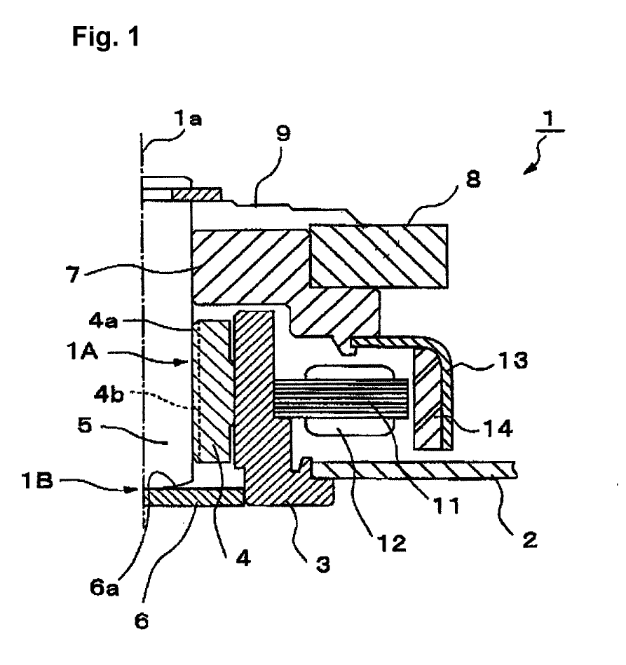

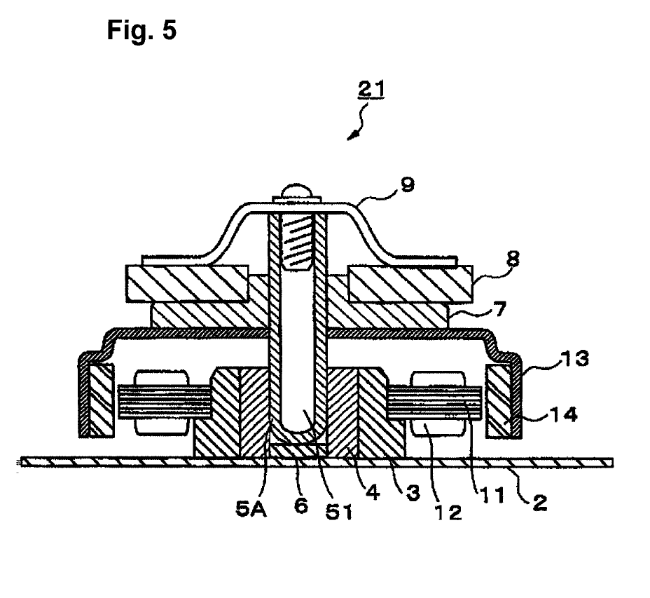

Next, FIG. 5 shows a cross-sectional view of another example of a rotation polygon mirror type optical deflector equipped with an air dynamic pressure bearing in accordance with the present invention. The basic structure of the optical deflector 21 is generally the same as that of the optical deflector 1 shown in FIG. 1. Accordingly the corresponding elements and parts are referred to by the same reference numbers, and their description is omitted. The optical deflector 21 of this example is characterized in that a rotor shaft 5A that is a component of its air dynamic pressure bearing has a void section 51 to reduce the weight of the rotor shaft.

Dynamic pressure generation grooves that are formed between a rotor shaft having a small diameter and a bearing member may not generate dynamic pressure at a sufficient magnitude. Accordingly, in forming an air dynamic pressure bearing, the external diameter of the rotor shaft 5A and the internal diameter of the bearing member 4 may need to be made larger. As a result, the rotor shaft 5A inevitably becomes large in the air dynamic pressure bearing, and its weight increases. Moreover, a rotation polygon mirror 8 is mounted on the rotor shaft 5A through a hub 7. As a consequence, the entire weight of the rotator body in the optical deflector 21 becomes large.

However, since the rotator body is supported by the air dynamic pressure bearing, the air dynamic pressure bearing can be brought to a floating state (non-contact state) at a lower rotation speed if the weight of the rotator section can be reduced. In other words, a lighter rotator section is preferable because the period of the contact rotation state can be shortened, and the amount of abrasion of the bearing is reduced, such that the bearing service life can be extended. Also, a lighter rotator section is preferable because the contact resistance between the shaft end section 51 of the rotor shaft 5A and the thrust bearing plate 6 can be reduced, and therefore the amount of abrasion of the thrust bearing section can be reduced, and its service life can be extended. In addition, by reducing the weight of the rotator section, power consumption for rotating the rotator section can be reduced.

In view of the above, in the optical deflector 21 of the present embodiment, the void section 51 is provided in an axial central area of the rotor shaft 5A, whereby the weight of the rotor shaft is reduced. The rotor shaft 5A equipped with the void section 51 may be formed by plastically deforming a metal plate by press work (for example, by drawing). By this method, a rotor shaft having a void section in its axial central area can be manufactured at low cost. It is noted that the metal plate is not limited to any particular material, and iron, aluminum, copper or the like can be used for the metal plate. Also, an external peripheral surface of the rotor shaft 51 may be coated by solid lubricant material to improve the rotation performance.

As described above, in accordance with the present invention, a shaft element that forms an air dynamic pressure bearing is rotatably supported by a bearing member, wherein the bearing element is formed from a sintered alloy and a solid lubricant material is disposed on an opposing surface of at least one of the shaft element and the bearing element. As a result, the amount of abrasion of the bearing, which occurs in a contact rotation state that takes place when starting or stopping a rotator body including the shaft element, can be reduced, and an air dynamic pressure bearing of the present invention can be used in a bearing section of a conventional liquid dynamic pressure bearing without modifying the bearing section.

Also, by using an air dynamic pressure bearing instead of a liquid dynamic pressure bearing, the rotation resistance is reduced at a high rotation speed because air has a lower density than liquid lubricant. As a result, the power consumption of the drive motor is reduced. Also, since air does not deteriorate like liquid lubricant material, the bearing service life is extended. For example, a bearing service life with a continuous rotation operation for about 50,000 hours can be guaranteed.

Next, in an air dynamic pressure bearing in accordance with the present invention, dynamic pressure generation grooves that are formed on a component of the bearing may preferably be formed to linearly extend in a direction in which a metal mold that is used to form the component is removed, in other words, in a direction of the bearing axis. As a result, bearing members having highly precisely formed dynamic pressure generation grooves are readily mass-produced at low cost.

Moreover, a rotation polygon mirror type optical deflector in accordance with the present invention is equipped with such an air dynamic pressure bearing. As a result, the service life of the bearing section is extended.

Also, by using a lightweight rotor shaft having a void section in its axial central area, various effects are achieved. For example, the weight of a rotator section including the rotation polygon mirror is reduced, the amount of abrasion of the bearing section is reduced, and the power consumption by the drive motor is reduced.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An air dynamic pressure bearing comprising:
a shaft element;
a bearing element relatively rotatably supporting the shaft element, the bearing element being formed from a sintered alloy;
at least one dynamic pressure generation groove for generating a dynamic pressure by air, formed between opposing surfaces of the shaft element and the bearing element; and
a solid lubricant material disposed on at least one of the opposing surfaces of the shaft element and the bearing element.

2. An air dynamic pressure bearing according to claim 1, wherein the bearing element is formed from a sintered alloy containing copper as a main component.

3. An air dynamic pressure bearing according to claim 1, wherein the bearing element is formed from a sintered alloy containing iron as a main component.

4. An air dynamic pressure bearing according to claim 1, wherein the solid lubricant material is provided as a lubrication film formed from resin that is mixed with at least one material selected from the group consisting fluorine, carbon and molybdenum disulfide.

5. An air dynamic pressure bearing according to claim 1, wherein the solid lubricant material is provided as an electrodeposition coating film formed from electrodeposition paint containing fluorine resin in which a copolymer including one of (a) through (d) listed below is mixed with bismaleimide resin,
(a) alkylester fluoride of acrylic acid or methacrylate acid,
(b) amino derivative of acrylic acid or methacrylate acid,
(c) hydroxy derivative of acrylic acid or methacrylate acid, and
(d) ester of styrene, acrylic acid or methacrylate acid.

6. An air dynamic pressure bearing according to claim 1, wherein the solid lubricant is solid lubricant powder that is sintered in a state mixed with metal powder for the sintered alloy.

7. An air dynamic pressure bearing according to claim 6, wherein the solid lubricant powder is at least one selected from the group consisting of carbon graphite, molybdenum disulfide and boron nitride, and the solid lubricant is formed by sintering the metal powder in a state mixed with resin that is mixed with the solid lubricant power.

8. An air dynamic pressure bearing according to claim 1, wherein the at least one dynamic pressure generation groove is formed in a bearing axial direction.

9. An air dynamic pressure bearing according to claim 1, wherein the at least one dynamic pressure generation groove includes a plurality of dynamic pressure generation grooves lineally extending in an axial direction of the shaft element.

10. An air dynamic pressure bearing according to claim 1, wherein the at least one dynamic pressure generation groove includes a plurality of dynamic pressure generation grooves lineally extending in an axial direction of the shaft element and defined between an external peripheral surface of the shaft element and an internal peripheral surface of the bearing element wherein the internal peripheral surface of the bearing element is formed in a regular octagon that is slightly larger than a regular octagon that circumscribes the shaft element.

11. An optical deflector comprising a rotation polygon mirror and an air dynamic pressure bearing rotatably supporting the rotation polygon mirror, the air dynamic pressure bearing comprising:
a shaft element;
a bearing element relatively rotatably supporting the shaft element, the bearing element being formed from a sintered alloy;
at least one dynamic pressure generation groove for generating a dynamic pressure by air, formed between opposing surfaces of the shaft element and the bearing element; and
a solid lubricant material disposed on at least one of the opposing surfaces of the shaft element and the bearing element.

12. An optical deflector according to claim 11, wherein the rotation polygon mirror is mounted on the shaft element of the air dynamic pressure bearing, and the shaft element is provided with a void section in an axial central area thereof.

13. An optical deflector according to claim 12, wherein the shaft element is formed from a plastically deformed metal plate with the void section provided therein.

14. An optical deflector according to claim 11, wherein the bearing element is formed from a sintered alloy containing copper as a main component.

15. An optical deflector according to claim 11, wherein the bearing element is formed from a sintered alloy containing iron as a main component.

16. An optical deflector according to claim 11, wherein the solid lubricant material is provided as a lubrication film formed from resin that is mixed with at least one material selected from the group consisting fluorine, carbon and molybdenum disulfide.

17. An optical deflector according to claim 11, wherein the solid lubricant material is provided as an electrodeposition coating film formed from electrodeposition paint containing fluorine resin in which a copolymer including one of (a) through (d) listed below is mixed with bismaleimide resin,
(a) alkylester fluoride of acrylic acid or methacrylate acid,
(b) amino derivative of acrylic acid or methacrylate acid,
(c) hydroxy derivative of acrylic acid or methacrylate acid, and
(d) ester of styrene, acrylic acid or methacrylate acid.

18. An optical deflector according to claim 11, wherein the solid lubricant is solid lubricant powder that is sintered in a state mixed with metal powder for the sintered alloy.

19. An optical deflector according to claim 18, wherein the solid lubricant powder is at least one selected from the group consisting of carbon graphite, molybdenum disulfide and boron nitride, and the solid lubricant is formed by sintering the metal powder in a state mixed with resin that is mixed with the solid lubricant power.

20. An optical deflector according to claim 11, wherein the at least one dynamic pressure generation groove is formed in a bearing axial direction.

21. An optical deflector according to claim 11, wherein the at least one dynamic pressure generation groove includes a plurality of dynamic pressure generation grooves lineally extending in an axial direction of the shaft element.

22. An optical deflector according to claim 11, wherein the at least one dynamic pressure generation groove includes a plurality of dynamic pressure generation grooves lineally extending in an axial direction of the shaft element and defined between an external peripheral surface of the shaft element and an internal peripheral surface of the bearing element wherein the internal peripheral surface of the bearing element is formed in a regular octagon that is slightly larger than a regular octagon that circumscribes the shaft element.
